(19) United States
(12) Patent Application Publication
(10) Pub. No.: US 2011/0283886 A1
(43) Pub. Date: Nov. 24, 2011

(54) Method And Apparatus For Regenerating A Filter

(75) Inventors: Karim Ladha, Coalville (GB); Andrew M. Williams, Leicester (GB); John E. Harry, Rutland (GB); Colin P. Garner, Leicestershire (GB); David W. Hoare, Loughborough (GB); David M. Heaton, Peterborough (GB); Jonathan G. P. Binner, Nottingham (GB)

(73) Assignee: PERKINS ENGINES COMPANY LIMITED, Peterborough (GB)

(21) Appl. No.: 13/121,704

(22) PCT Filed: Sep. 30, 2008
(86) PCT No.: PCT/EP08/08298

§ 371 Date: Aug. 8, 2011

(51) Int. Cl. B01D 46/50; B01D 39/20

(52) U.S. Cl. 95/278; 55/301; 55/291; 55/529; 55/523

(57) ABSTRACT

The present disclosure refers to a method for regenerating a filter adapted to remove particulate material from a gas. The disclosed method comprises at least producing at least one electric arc discharge pulse, the at least one electric arc discharge pulse being adapted to generate at least one pressure wave so that the particulate material is being dislodged from the filter. In addition, the disclosure refers to a filter regenerating arrangement and a diesel particulate filter.

### TECHNICAL FIELD

The present disclosure refers to a method for regenerating or cleaning any kind of a particulate collecting surface or preferably a filter, e.g. a diesel particulate filter, adapted to remove particulate material from a gas. Furthermore, the present disclosure refers to a filter regenerating arrangement, e.g., a diesel filter regenerating arrangement, and to a diesel particulate filter (DPF) as such.

### BACKGROUND

Internal combustion engines and the like, as well as, e.g., stationary hydrocarbon burning equipment, tend to emit, via their exhaust systems, carbonaceous particles commonly referred to as particulates or particulate material as, e.g. soot and/or ash. Whilst efforts are being expanded towards reducing particulate emissions at the source, particulate filters in the exhaust systems of such equipment are useful in helping to meet increasingly strict environmental legislation and public expectations.

Particulate filters which may be regenerated are generally known. Basically, the known regeneration techniques may be classified into three groups of regeneration techniques. In the first group, the regeneration is effected by oxidation of the accumulated particulates, like soot, using excess oxygen in the exhaust, or using trace quantities of NO₂ from NOₓ emissions of the engine, i.e. a thermal process is carried out. However, the starting temperature of the corresponding oxidation reaction is relatively high, e.g. higher than 600° C. A second group of regeneration techniques uses a non-thermal plasma for producing highly excited electrons that interact with gas molecules, thus creating radicals. These radicals assist in further enhancing carbon oxidation. A third group may comprise regeneration techniques where filters are regenerated by means of mechanical action, flow and/or pressure waves.

WO 01/04467 discloses an apparatus and a method for removing particulates from a gas stream. A ceramic monolith filter having a depth less than 100 mm uses a first electrode to produce an atmospheric local discharge near a first end of the filter. Although the combination of the reduced-depth ceramic filter and atmospheric load discharge allegedly provided far more efficient particulate removal and filter regeneration performance than all known arrangements, it has been established that the performance may be improved still further.

WO 2007/023267 A1 discloses an apparatus and method for removing particulates from a gas stream, which also uses an atmospheric load discharge. Both above-identified documents use an atmospheric load discharge in a gap between an electrode and the filter body. Due to this produced atmospheric load discharge, the particulate material trapped in the filter acts as grounding sites for the atmospheric load discharge, and the discharge oxidizes the particulate material. Due to the use of the atmospheric load discharge, regenerating the filter requires the filter material be designed to resist high temperatures, e.g. more than 600° C. or even more than 1000° C. In addition, the power consumption may be relatively high for regenerating a particulate filter like a diesel particulate filter. A very similar method and filter arrangement is also disclosed in EP 1 192 335 B1.

A method and device of removing electrically-conducting particles from a stream of gas is disclosed in WO 94/07008. A particle-contaminated filter is regenerated in situ by subjecting the trapped particles to a spark discharge and/or a short duration electric arc discharge for a length of time such that the particles ignite and are thus converted by combustion into gaseous compounds.

US 2001/0042372 A1 discloses an exhaust gas filtration system using a non-thermal plasma generator that periodically, or continuously, oxidizes carbon deposited or trapped within a filter disposed downstream of a non-thermal plasma generator. EP 1 219 340 A1 also refers to a non-thermal plasma reactor capable of lower power consumption to be used in a method for treating a combustion exhaust stream. Another non-thermal plasma reactor having a lower power consumption is known from US 2002/0076368 A1.

Mechanical means for cleaning the dust collecting surfaces of electric gas purifying chambers are known from GB 257,283. According to this disclosed arrangement, dust collecting surfaces are arranged and constructed so that they will bend when fluctuations occur in the pressure of gas flowing through purification chambers. Owing to the bending or yielding movements of the dust collecting surfaces, dust adhering to them is caused to fall off. The fluctuations in pressure may occur automatically or may be produced artificially in order to ensure a uniform shaking of the dust collecting surfaces. Here, the fin walls of the filter means will bend in accordance with the changes in the gas or air pressure being applied to their exterior.

Another system for removing particulates from a filtering device of machine is shown in US 2007/0137150 A1. Here, the system may include a flow assembly configured to direct a flow of gas through the filtering device, with one ore more elements of the flow assembly being removably attached to a first opening of the filtering device. The system may also include a sound generation assembly configured to direct sound waves toward the filtering device to remove particulates from the filtering device. For removing matter from the filtering device, a heater or some other heat source may be used to increase the temperature of the filtering device. The heater may also increase the temperature of trapped particulate matter above its combustion temperature, thereby burning away the collected particulate matter and regenerating the filtering device while leaving behind ash.

U.S. Pat. No. 5,900,043 discloses an electrostatic filter with process for fast cleaning without breaking confinement using an acoustic wave generator.

WO 2008/054262 A1 discloses a device for cleaning a diesel particulate filter. A vacuum source is positioned to draw a cleaning fluid and waste material through the filter. A collector is positioned to receive the waste material released from the filter during a filter cleaning event.

In US 2005/0106985 A1 a reactor comprises a reactor body having a generally elongated form made from a dielectric material and crossed by separate parallel channels extending longitudinally within the body. Electrodes are provided for generation of discharge coronas in the body for initiating the treatment of a gas flow.

A regenerative soot filter device and methods for regenerating a soot filter using a microwave generator are disclosed in EP 1 304 456 A1.

In DE 103 45 925 A1 a particulate filter uses a device adapted to generate an alternating electrical field for heating up and burning the particulate matter.

All prior filter regenerating systems may require large and complex systems. The present disclosure is directed, at least in part, to improving or overcoming one or more aspects of prior filter regenerating systems.

### SUMMARY OF THE DISCLOSURE

According to a first aspect of the present disclosure a method for regenerating a filter adapted to remove particulate material from a gas may comprise producing at least one electric arc discharge pulse, preferably at least one series of electric arc discharge pulses, wherein the at least one electric arc discharge pulse is adapted to generate at least one electric arc discharge and thereby at least one pressure wave for dislodging the particulate material including soot, and other particulate materials trapped by the filter including ash.

According to a second aspect of the present disclosure a filter regenerating arrangement may comprise a pulse generating device. The pulse generating device may be adapted to generate at least one electric arc discharge pulse, wherein the at least one electric arc discharge pulse is adapted to generate at least one electric arc discharge and thereby at least one pressure wave that causes particulates trapped in the filter to be dislodged from the filter. The arrangement optionally further comprises a particulate removing device adapted to remove the already dislodged particulate material from the filter.

Another aspect of the present disclosure refers to a diesel particulate filter which may consist of a filter material adapted to trap particulate material, the filter material having a maximum temperature resistance of about 600° C., preferably of about 500° C. to 550° C., or more preferably of about 400° C. to 450° C. The diesel particulate filter may further comprise at least two electrodes adapted to generate at least one electric arc discharge in the filter caused by at least one electric arc discharge pulse that causes the particulate material trapped in the filter to be dislodged from the filter by at least one pressure wave.

A further aspect of the present disclosure refers to the use of at least one electric arc discharge configured to not burn a particulate material trapped in a filter but to dislodge the particulate material trapped in the filter from the filter, preferably by at least one pressure wave.

It is to be understood that both the foregoing general description and the following detailed description are exemplary and explanatory only and are not restrictive of the disclosure.

Other features and aspects of this disclosure will be apparent to the skilled person based upon the following description, the accompanying drawings and the attached claims.

### BRIEF DESCRIPTION OF THE DRAWINGS

FIG. 1 shows a schematic block diagram of an exemplary embodiment of a filter regenerating arrangement according to a first exemplary embodiment of the present disclosure,

FIG. 2 is a schematic perspective view of an exemplary embodiment of a filter to be used, e.g., in the filter regenerating arrangement shown in FIG. 1,

FIG. 3 is a diagram sectional view of a filter shown, e.g., in FIG. 2, including electrodes according to an exemplary arrangement pattern,

FIG. 4 is a diagram longitudinal view of the filter shown in FIGS. 2 and 3.

FIG. 5 is a schematic perspective view of another exemplary embodiment of a filter to be used, e.g., in the filter regenerating arrangement shown in FIG. 1,

FIG. 6 is a block diagram of an exemplary embodiment of a pulse generating device to be used in a filter regenerating arrangement, e.g., as shown in FIG. 1,

FIG. 7 is an example of a schematic circuit diagram used to produce electric arc discharge pulses,

FIG. 8 is a graph illustrating an exemplary embodiment of a series of electric arc discharge pulses generated e.g. by means of a circuit as shown in FIG. 6 or 7,

FIG. 9 shows various exemplary embodiments of one electric arc discharge pulse produced e.g. by means of the circuits as shown in FIGS. 6 and 7, wherein the pulses have different powers or shapes or amplitudes.

FIG. 10 is a schematic block diagram of a laboratory test arrangement representing an exemplary filter regenerating arrangement according to the present disclosure,

FIG. 11 shows a pre regeneration curve and opposed “three-minute” post regeneration curve resulting from tests using the test arrangement shown in FIG. 10,

FIG. 12 shows the test results obtained by using the laboratory test arrangement shown in FIGS. 10, and

FIG. 13 shows a longitudinal section of a filter having inlet channels and outlet channels partially treated according to the present disclosure.

### DETAILED DESCRIPTION

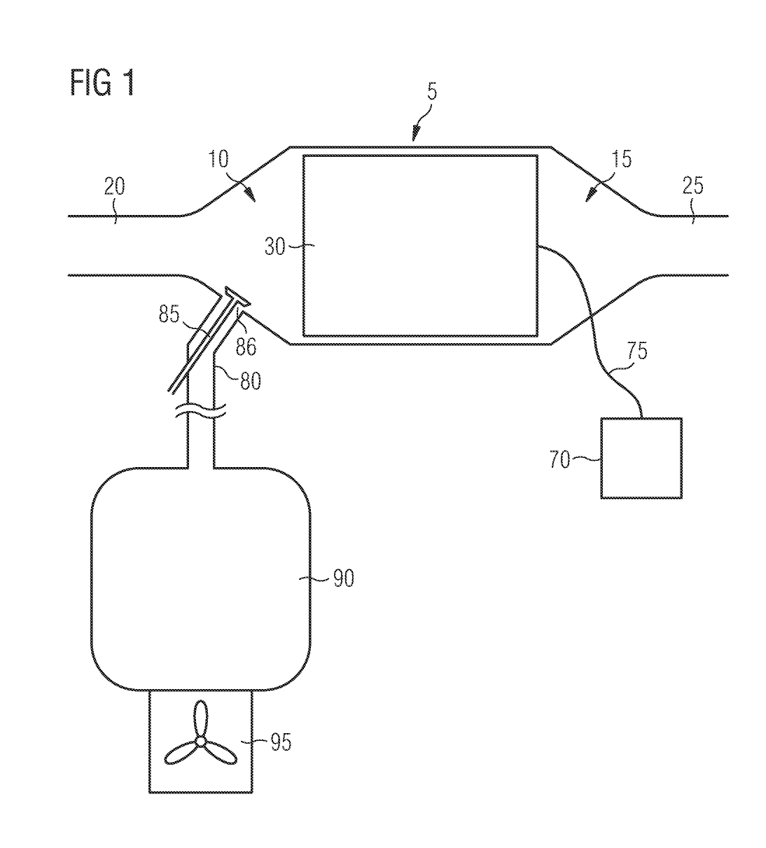

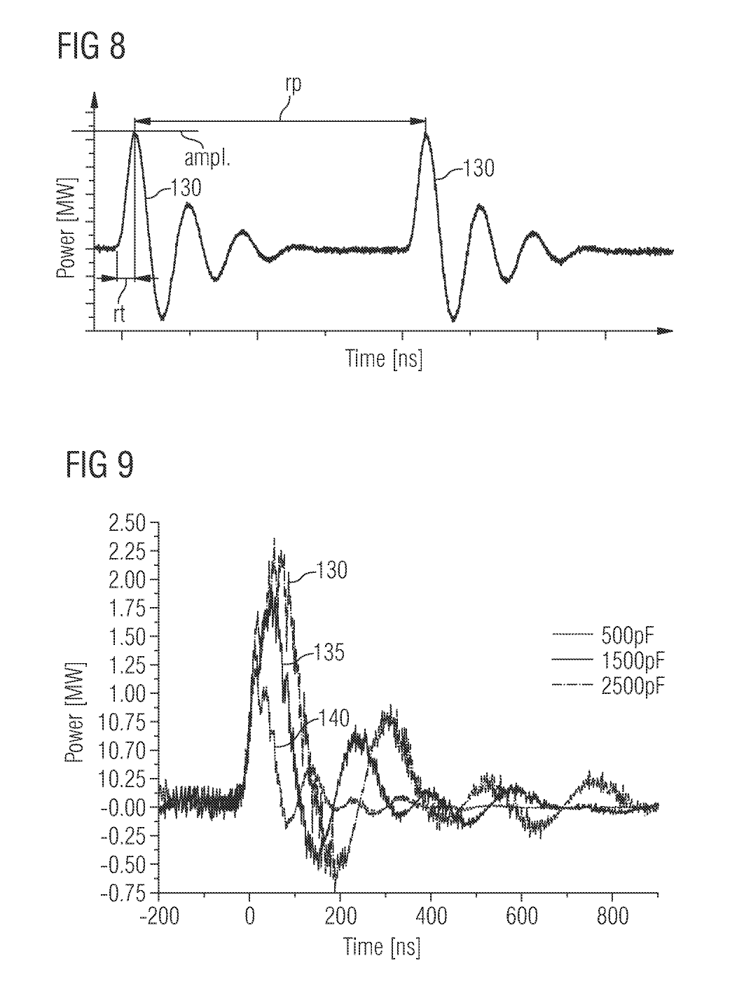

Referring to the drawings, FIGS. 1-4 and 6-9 illustrate an exemplary embodiment of a non-thermal regenerating filter arrangement 5 according to the present disclosure.

FIG. 1 a shows a schematic block diagram of the non-thermal filter regenerating arrangement 5 adapted to remove particulate material 120 from a gas 40, e.g., exhaust gas from an internal combustion engine. The exhaust gas 40 may have a relatively high temperature when it leaves the internal combustion engine (not shown) which can be, for example, a diesel engine. The filter arrangement 5 shown in FIG. 1 may comprise a housing 6 in which a filter device 30 is accommodated. A filter inlet 10 connects to the housing 6. An exhaust conduit 20 is connected to the filter inlet 10. A filter outlet 15 may be connected to the housing 6 on another side of the filter device 30. The filter outlet 15 may end in an exhaust conduit 25 for filtered gas 50.

In the present exemplary embodiment shown in FIG. 1, a branch line 80 is in fluid communication with the filter inlet 10. A storage container 90 which may be equipped with an extractor fan 95 is connected to the branch line 80. A movable valve 85 may be arranged at the port 86 so that the port 86 can be opened and closed by means of the valve 85. Of course, other controllable means may be provided or adapted to close and open the connection between the filter inlet 10 and the storage container 90.

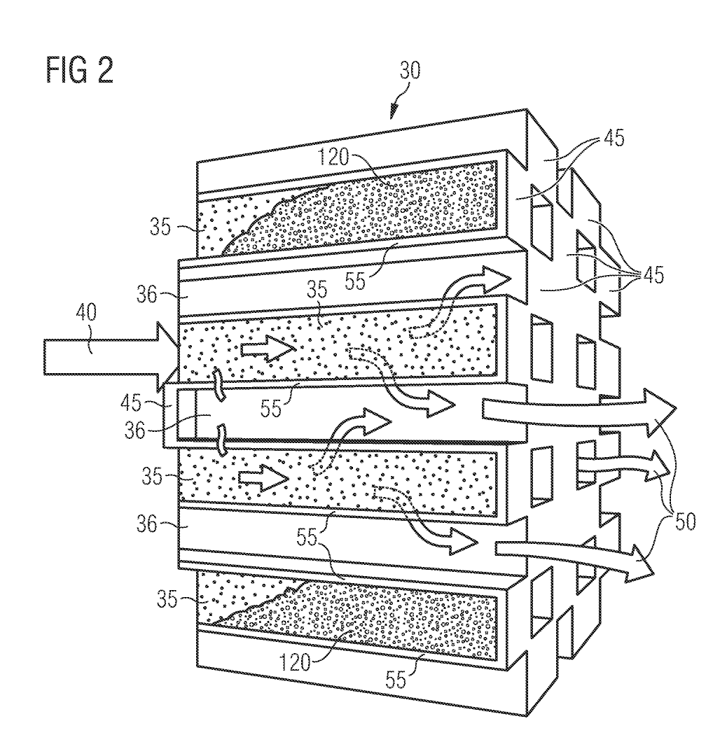

As schematically shown, a pulse generating device 70 is connected to electrodes 100, 110 (see, e.g., FIGS. 2-4, 6, and 7) via an electrical wiring 75. The electrodes are arranged within the filter device 30 as shown, e.g., in FIGS. 2-4.

Exhaust gas 40 entering the filter arrangement 5 via the exhaust conduit 20 and the following filter inlet 10 is required to pass into the filter device 30. The cleaned exhaust gas 50 may exit the filter 30 via the filter outlet 15 and the attached exhaust conduit 25. Detailed explanations with regard to the construction and design of the filter device 30 and the path the exhaust gases take within the filter device 30 will follow below with reference to FIGS. 2-5.

During the normal operation of the filtering device 30, i.e. when cleaning the exhaust gas 40 entering into the filter inlet 10, the valve 85 closes the port 86 of the branch line 80.

If particulate material 120 has been dislodged from the filter device 30 according to a method disclosed above and explained in more details below, the valve 85 is actuated so that the port 86 is open. The extractor fan 95 may be activated to suction the particulate material 120 already dislodged from the filter device 30 and loosely lying, e.g., in cells or channels 35 of the filter device 30. The shape of the channels 35 may be tubular, and, e.g. the channel opening width may be approximately 2 mm. However, other dimensions of the channels may be appropriate.

Dislodging of at least a part of the trapped particulate material 120 from the filter device 30 may be achieved by generating one or more series of electric arc discharge pulses between a plurality of electrodes 100, 110 distributed within the filter 30. The series of electric arc discharged pulses 130, 135, 140 is generated so that pressure waves are produced, and that cause the particulate material 120 to be dislodged or separated from the filter 30. The one or more series of electric arc discharge pulses 130, 135, 140 may be generated when the engine (not shown) is shut off and, therefore, when no exhaust gas 40 is entering the filter element 30.

FIG. 2 shows a schematic perspective view of an exemplary embodiment of a filter device 30 which may be embodied, e.g. as a monolithic filter such as a monolithic ceramic filter. The filter device 30 may comprise a plurality of cells 35, 36 arranged in parallel to each other. In the exemplary embodiment of the filter device 30 shown in FIG. 2, the cells 35 are in fluid communication with the filter inlet 10. One end of each cell 35 is closed, e.g., by a plug 45. The plug 45 may be inserted into and fixed in the cell 35. As an alternative, the plug may be integrally formed with the cell 35.

The cells 36 may be in fluid communication with the filter outlet 15, and these cells 36 are provided with an end plug 45 on the opposite side of the end plugs 45 of the cells 35. The filter walls 55 separating the cells 35 from the cells 36 are designed and formed so that the particulate material 120 in the exhaust gas 40 entering the filter device 30 is trapped in filter walls 55. Hence, the filtered or purified exhaust gas 50 does not contain any particulate material 120, or only contains a reduced amount of particulate material 120 as compared to the exhaust gas 40 entering the filter device 30.

As shown in FIG. 2, a cell 35 is in fluid communication with the filter inlet 10 and is surrounded by the cells 36 which are in fluid communication with the filter outlet 15. In other words, in this exemplary embodiment of a filter device 30, cells 35 and cells 36 may be arranged in an alternating pattern.

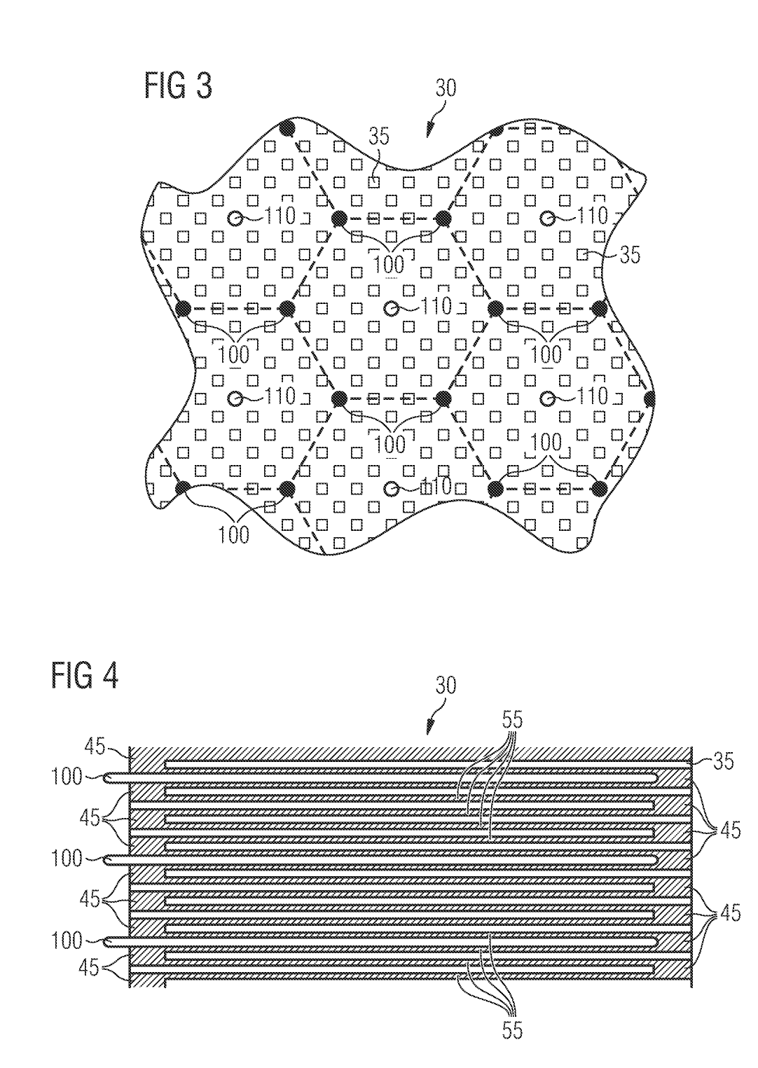

FIG. 3 relates to the arrangement of the electrodes 100, 110, e.g., within the filter device 30. It has to be noted that the arrangement of the electrodes 100, 110 shown in FIG. 3 is only one exemplary embodiment, and, of course, other patterns of arrangement of electrodes 100, 110 are possible. Here, electrodes 100, i.e. an electrode which may be connected to a terminal of a power supply 225, preferably a DC power supply, are arranged in a hexagonal pattern around an active electrode 110, i.e. an electrode which may be connected to a positive pole or terminal of the power supply 225. The above terminal may be connected with a negative pole of a power supply 225.

In certain embodiments, it might be appropriate to arrange electrodes 100 around an active electrode 110, e.g., in pentagonal, triangular or other patterns. A basic arrangement may include a electrode 100 in a spaced relationship with another active electrode 110. The series of electric arc discharge pulses 130, 135, 140 is generated between the electrodes 100 and the one or more active electrode(s) 110 wherein the electric arc discharge pulses 130, 135, 140 are so shaped or adapted such that pressure waves are produced which dislodge the particulate material 120 from the filter 30, e.g., due to pressure waves propagating through the filter, in particular the filter walls 55.

In the present exemplary embodiment of a filter arrangement 5 according to the present disclosure, the electrodes 100, e.g., a ground electrode, and the active electrodes 110 may be straight wire electrodes, but other forms of electrodes 100, 110 can be used, e.g., helical or spiral wire electrodes or the like.

FIG. 4 shows a representative arrangement of electrodes 100 within the filter device 30 in a longitudinal section of the filter device 30, e.g., as shown in FIGS. 2 and 3. In the shown arrangement, two electrodes 100 are spaced from each other by a distance, e.g., of 5 channels 35, 36. However, other distances between two electrodes 100 may be appropriate, e.g. depending on the thickness of the filter walls 55, the material of the filter walls 55 etc. In another exemplary embodiment an electrode 100 may be arranged within every filter wall 55, or in every second or third or fourth, etc. wall 55. An active electrode may be disposed in a cell 35, e.g. not contacting a filter wall 55.

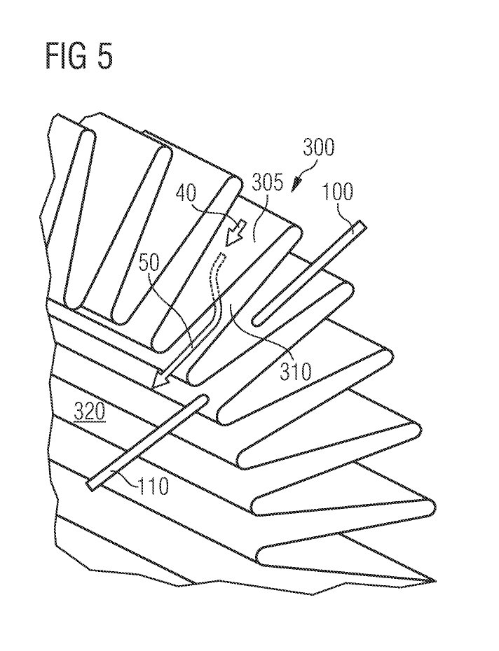

A further exemplary embodiment of a filtering device 300 is shown in FIG. 5. As an alternative to the filtering device shown in FIG. 2, a filtering device 300 has pleated filter walls 305, 310. The pleated filter walls 305, 310 may be arranged on a circle around a center line (not shown), e.g., of a cylinder shaped filtering device 300. An exhaust gas 40 contaminated with the particulate material 120 is required to pass from the outside of the filtering device 300 through the filter walls 305, 310 into an interior 20 of the filtering device 300. Upon passing the filter walls 305, 310, the purified exhaust gas 50 may be guided at one of the front ends of the filtering device 300 out off the filtering device 300. For dislodging or loosening the trapped particulate material from the filter walls 305, 310 at least one pair of electrodes 100, 110 is arranged, for example, on an outer side of the filtering device 300, and the inner side of the filtering device 300, respectively. Consequently, at least one filter wall 305, 310 is arranged between the two electrodes 100, 110. If at least one series of pulses according to the present disclosure is generated, electric arc discharges are generated and pressure waves are produced due to the special kind of series of electric arc discharge pulses, the pressure waves cause the particulate material 120 trapped in the filter walls 305, 310 to dislodge from the filter walls 305, 310.

In case that the filtering device 300 is arranged in a manner that its center line is vertically, the dislodged particulate material 120 may fall down due to the gravity and can be collected in a storage bag or the like. As an alternative, the dislodged particulate material 120 may be blown into a container or the like by, e.g., a fan (e.g. a low pressure fan) or any other suitable technical device. A further alternative may be that the dislodged particulate material is sucked by, e.g., a vacuum device or any other suitable technical device.

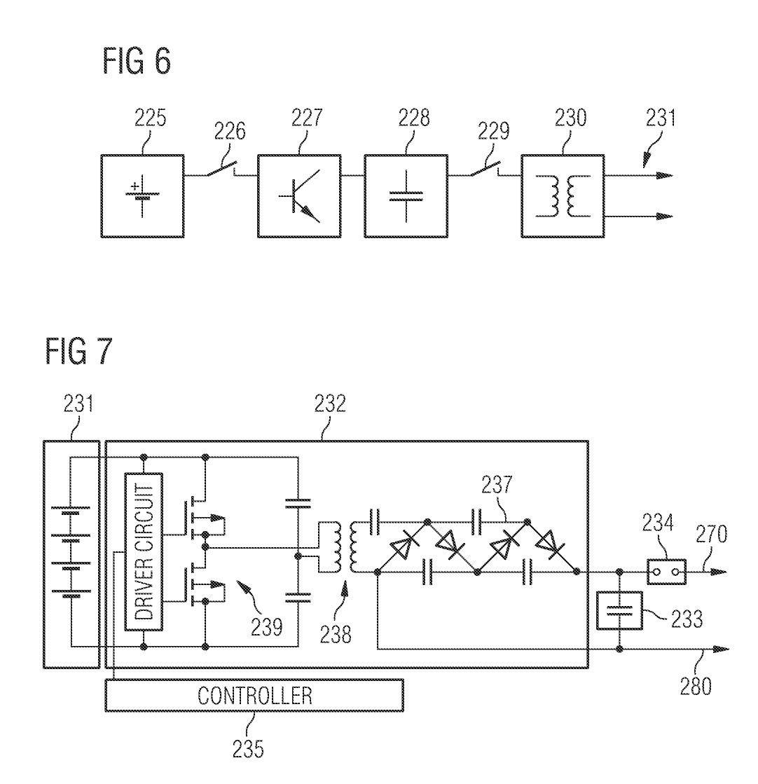

FIG. 6 shows a diagram of power supply components may be needed to reproduce the regeneration process although the process is not limited to being produced by these components alone. The energy is supplied by an electrical power source 225, which may conveniently be the battery of a vehicle or other local electrical source. The regeneration process is started by connecting this to the other power supply components through a switch 226. The switch 226 may be a physical connection or, more likely, an electronic device or control implementation embedded within a power converter assembly 227.

The power converter 227, where required, will convert the electrical power supplied by the electrical power source 225 into a form suitable for storage on an energy storage component 228. The energy storage component 228 would be conveniently a capacitor, although another storage devices or device is possible. The device 228 may be required to produce the current waveform at its output, as controlled by the user through a control strategy embedded within one of the components or externally. This may be accomplished by releasing the energy stored in the storage component(s) 228 using a second switch 229, which may be a physical implementation or be an embedded controlled component or process. The stored energy may need to pass through a second power converter device 230, which could conveniently be a transformer, in order to achieve the required voltage and current level.

In some implementations the converter, 230, may not be required. The output of the final stage is then connected physically to the electrodes 100, 110.

FIG. 7 shows one possible power supply topology. This power supply uses a battery as an energy source 231. The battery 231 is connected to a power converter 232 which converts the battery voltage into a higher voltage capable of powering the electrodes 100, 110 within the filter. The high voltage output may be modified by changing aspects of the power converter 232, sub-circuits 237, 238, 239. The high voltage output of the converter 232 is current limited by the well known action of the sub-circuit 237. The sub-circuit 237 may be a diode voltage multiplier rectifier circuit. The output current of the sub-circuit 237 charges an energy storage capacitor 233. When the output discharge pulse is required, the capacitor is switched onto the electrodes (connections via 236) using a spark gap 234. The spark gap 234 may be controlled or self commutating, depending on the degree of control required.

The power supply operation uses the controller 235 which may be a microcontroller or a different analogue or digital circuit. The controller 235 determines the operation of a half bridge inverter 239 which drives the high voltage transformer 238. The regeneration system is turned on and off by the action of the controller.

This exemplary embodiment of a circuit for generating a series of electric arc discharge pulses is so designed that the electrodes 100, 110 connected to connecting lines 280 and 270, respectively produce electric arc discharges which in turn result in pressure waves within the filter device 30, 300. Preferably, the rising time rt of a pulse 130 causing the electric arc discharge may be quite short, for example 1 ns to 1000 ns, preferably about 10 ns to 200 ns, more preferably about 80 ns to 120 ns, even more preferably about 100 ns. The maximum amplitude of a pulse may be 1.00 MW to about 5.00 MW, preferably about 1.25 MW to 2.50 MW. The peak discharge current pulse may be greater than 100 A over a period of about 200 ns and the supply voltage may be up to 20 kV. Preferably the generated electric arc discharge pulses 130; 135; 140 have a peak pulse current of about 10 A to 1000 A, preferably about 100 A. A series of electric arc discharge pulses may include pulses 130; 135; 140 having a pulse energy release per arc length of about 0.1 mJ/mm to 100 mJ/mm, preferably between 1 mJ/mm to 10 mJ/mm. The pulse rise time rt of each electric arc discharge pulse 130; 135; 140 may be about 10⁻⁹ s to 10⁻⁷ s, preferably 10⁻⁸ s. The number of pulses may be up to 10⁶ per litre of filter volume, preferably 10³ pulses per litre to 10⁵ pulses per litre, preferably the pulse repetition rate is between about 5 Hz to 50 Hz, preferably about 10 Hz to 20 Hz. The filter volume is determined by the external dimensions of the filter.

FIG. 9 shows various exemplary embodiments of a single electric arc discharge pulse 130, 135, 140 generated, e.g., by means of capacitors of 500 pF, 1500 pF, and 2500 pF.

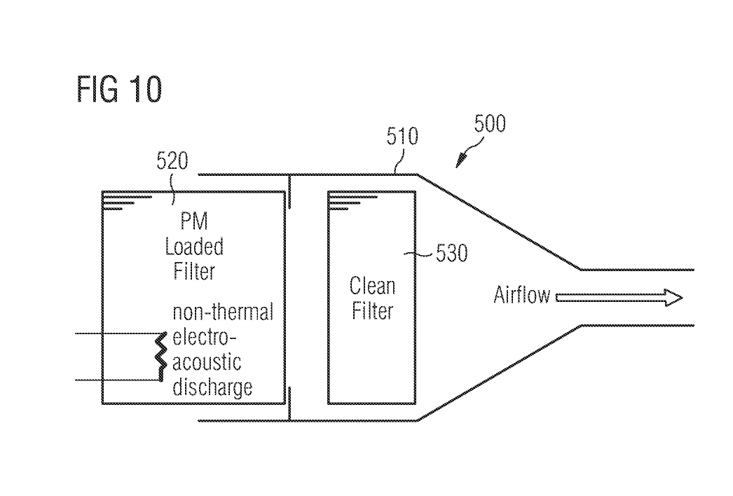

FIG. 10 is a schematic block diagram of a laboratory test filter arrangement adapted to demonstrate the method according to the present disclosure. The laboratory test filter arrangement 500 may comprise a housing 510 in which a filtering device 520 loaded with particulate material is arranged. Due to, e.g., an arrangement of electrodes 100, 110 within the filtering device 520 and producing at least one series of electric arc discharge pulses, particulate material may be dislodged from the filtering device 520 or any other surface where filtered material needs to be removed.

A clean filter 530 is arranged in a distance to the filtering device 520 downstream of the filtering device 520. The filtering device 520 is a 200 cpsi cordierite WFF loaded with particulate matter to 3.8 g/l. Particulate material was treated according to the present disclosure to dislodge the particulate material from the filter surface. A small domestic 600 W vacuum cleaner was used to draw air through the filter, transferring the trapped particulate material into the second clean filter 530 to allow mass measurements of the amount of particulate material removed. Fifteen electric arc discharge pulses, with an average power consumption of 16 W each were applied successively to the filter for three minutes. Back pressure and mass measurements were used to determine the effect of the method treatment according to the present disclosure. This configuration was only used to audit the mass removal of the particulate material by collecting the particulate material removed from the loaded filtering device 520 which has to be regenerated, and collecting it in the filter 530 downstream and weighing the loss and gain in weight respectively.

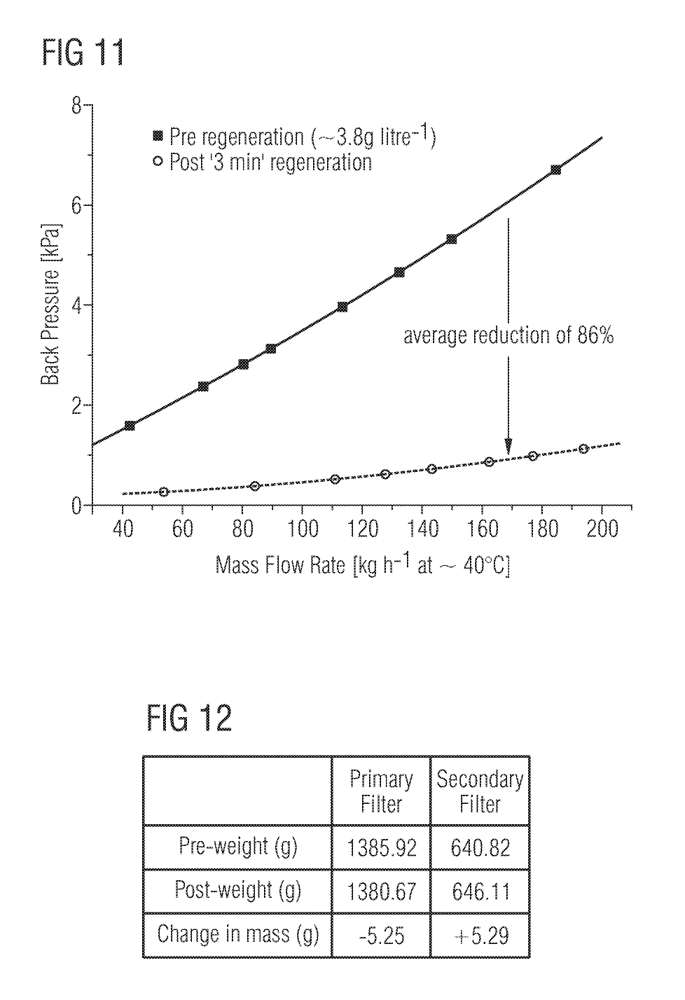

The table shown in FIG. 12 shows the change of mass of the two filters 520, 530. It shows that fifteen active electrodes supplied by a repetively pulse electric arc discharge for three minutes electric arc discharges removed about 5.3 g of particulate material from the primary filter 520. This reduces the back pressure of the filter by an average of 86% between 50 and 200 kg/h as shown in FIGS. 11. 0.5 to 1 g/per litre particulate material, (in particular 1.22-2.44 g) was within the filter's structure, corresponding to the depth bed filtration mode. This means that about 7.4 g of the trapped particulate material was in the cake layer. Given that only 72% of the filter volume was treated with the method according to the present disclosure, the removal of about 5.3 g (71%) of the cake layer indicates that the method according to the present disclosure is very effective at removing the particulate material cake layer with low power and over short durations.

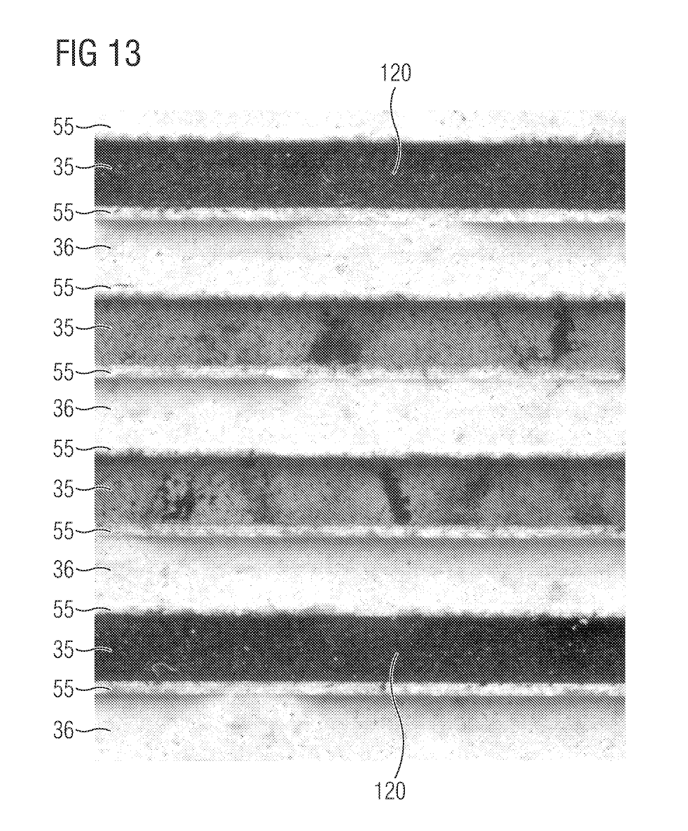

Finally, FIG. 13 shows a longitudinal section of a filtering device 30 in which, as a result of the method according to the present disclosure, particulate material 120 was caused to dislodge from the filter walls 55 in some channels 35.

### INDUSTRIAL APPLICABILITY

The disclosed regeneration filter arrangement 5, shown in FIG. 1, may be used for regenerating a filtering device 30, or a filtering device 300, and/or other suitable filtering device or matter collection devices known in the art. Such devices may be useful in any applications where the removal of matter, e.g., particulate material or particulates, may be desired. For example, the method and arrangement disclosed may be used on diesel, gasoline, natural gas, and/or other combustion engines or furnaces known in the art. Other applications are also possible, e.g. in pharmaceutical industry for the generation of aerosols from particulate material. The disclosed method and apparatus may also be used in inhalers, heat exchangers, in particular clean heat exchangers, etc., and for fuel injector cleaning

As discussed above, the disclosed method and arrangement 5 may in particular be used in conjunction with any work machine, on-road vehicle, off-road vehicle, stationary machine, and/or other exhaust-producing machine to remove matter from a filtering device mounted thereon.

During regeneration, the filtering device 30, 300 may be kept in its normal operating position. However, it is also possible to mount a filtering device 30, 300 in a replaceable manner, and to remove a filtering device 30, 300 loaded with particulate matter to install it in a stationary regenerating apparatus. In such a stationary regenerating apparatus a number of electrodes 100, 110 may be arranged such that the filtering device 30, 300 may be inserted and then, subsequently, one or more series of electric arc discharge pulses are generated according to the disclosed method causing pressure waves propagating through the filtering device 30, 300, and, thereby, the particulate matter 120 is being dislodged.

The disclosed method and apparatus may be characterized by the electric arc discharge which loosens the particulate material, e.g., the soot and/or ash etc., so it can be, e.g., subsequently, removed with much less pressure or flow requirements than processes that do not use the disclosed method.

The soot and/or ash and/or other particulate material may be gathered in a separate or incorporated container, e.g. a container as mentioned above. If a separate regenerating apparatus is provided, the particulate material dislodged from the filtering device 30, 300 may be blown out of the filtering device 30, 300, or the dislodged particulate material 120 may be sucked in an associated container, e.g., by a blowing fan or vacuum device. For removing particulate material 120 from the filtering device 30, 300 an internal combustion engine (not shown) may be turned off causing that combustion ceases and there is no exhaust flow from the internal combustion engine to its exhaust conduit 20. The valve 85 may be actuated by a controller (not shown), machine operator or technician to open the port 86 of the branch line 80 connecting the filtering inlet 10 to the storage container 90. Subsequently, the filtering device 30, 300 may be regenerated by actuating the pulse generator device 70.

Alternatively, the opening of the port 86 via the valve 85 may be conducted after the particulate material being dislodged, i.e. actuating the pulse generating device 70, so that after the particulate matter 120 being partly or fully dislodged from the filtering device 30, 300, a connection between the filtering inlet and the storage container 90 is created.

The dislodging of the trapped particulate matter 120 from the filtering device 30, 300 may comprise the generation of at least one series of electric arc discharge pulses, which might have a defined repetition rate and includes a number of identical or similar pulses according to the defined repetition rate. Between one series of electric arc discharge pulses and a following series of electric arc discharge pulses a defined time period may be set. In an exemplary embodiment of the present method one series of electric arc discharge pulses is generated until a desired amount of particulate matter 120 or a defined percentage of estimated particulate matter 120 trapped in the filtering device 30, 300 may be dislodged.

For example, a series of electric arc discharge pulses may be generated for the time period of a few seconds up to a few hours. In another exemplary embodiment one series of electric arc discharge pulses is generated for about a few seconds to about a few minutes, and a following other series of electric arc discharge pulses having the same or another repetition rate may follow for another or the same time period.

The number of series of electric arc discharge pulses and/or a repetition rate and/or the amplitude and rising time of a pulse of a series of electric arc discharge pulses may be adapted to obtain an optimized regeneration of a filtering device 30, 300. For example, the rising time of each electric arc discharge pulse of a series of electric arc discharge pulses may be within a range of about 1 ns to 1000 ns or more, preferably about 100 ns, more preferably 5 ns to 50 ns, more preferably about 10 ns.

It has to be noted that each and every intermediate value within the ranges mentioned above are part of the disclosed method. The step of removing the dislodged particulate matter 120 from the filtering device 30, 300 may follow between two subsequent series of electric arc discharge pulses, or after termination of generating the one or more series of electric arc discharge pulses. The removal of the dislodged particulate matter 120 may be carried out alternately with one or more series of discharge pulses or after termination of dislodging particulate matter 120 from the filtering device 30, 300.

If the dislodged particulate matter 120 has to be removed the extraction fan 95 may be activated to suck the dislodged particulate matter 120 within the channels 35 out of the filtering device 30. It may be also possible to suck the dislodged material 120 out from the outside of the filtering device 300. A fan or extractor could potentially be a fan or blower feeding air to the other side of the filter and used to blow the particulate material out of the filter.

When the dislodged particulate matter 120 is transferred to the container 90 the container 90 may be discharged, or the whole container 90 may be disconnected from the branch line 80 to discharge the container 90 at another place or regenerated in situ.

As mentioned above at least one series of electric arc discharge pulses may be generated to dislodge particulate material 120 from a filtering device 30, 300 by producing electric arc discharges causing pressure waves propagating through the filtering device 30, 300. The rise time rt and/or the maximum amplitude amp and/or the number of pulses and/or the number of series of electric arc discharge pulses may influence the generation of pressure waves propagating through the filtering device 30, 300.

The presented method and the regeneration filter arrangement 5 may result in a lower energy consumption compared to the known systems. Furthermore, an advantage may be that less CO₂ is produced. In addition, less or even no ash may be left in the filter. The presented method may result in a lower maximum temperature for which the filtering device 30, 300 has to be designed, and, therefore, a filtering device may consist of less expensive and/or more effective materials.

Generally speaking, according to the present disclosure, the dislodged particulate material, e.g. soot and/or ash, may be removed from the filter after the particulate material was dislodged by the special electric arc discharge pulse(s) or at least one special series of electric arc discharge pulses. In other words, a core of the present disclosure may be the use of at least one special electric arc discharge which results in dislodging particulate material from the filter without burning the particulate material. Consequently, the disclosed method may be a method for regenerating any filter adapted to remove particulate material from a gas by relatively low temperatures compared to prior art solutions where the particulate material is burned. The particulate material trapped in the filter will, therefore, not be burned but rather mechanically knocked out of the filter.

According to an aspect of the disclosed method the “autoselectivity” may be important in that an electric arc discharge locates on particles of soot i.e. where it is of most use, not on a clean filter surface. However, even in case a filter is not loaded with soot but with other particulate material as, e.g., ash or other contaminations, the disclosed method may work. Hence, the removal of ash may an additional advantage of the disclosed method and apparatus, as at present ash formation limits the life of particulate filters as, e.g., a diesel particulate filter, and the present disclosure may allows them to be used longer.

Another aspect is that the disclosed apparatus method may be compact, and both the disclosed method and the apparatus could be low cost.

Although the preferred embodiments of this invention have been described herein, improvements and modifications may be incorporated without departing from the scope of the following claims.

It is explicitly stated that all features disclosed in the description and/or the claims are intended to be disclosed separately and independently from each other for the purpose of original disclosure as well as for the purpose of restricting the claimed invention independent of the compositions of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. A method for regenerating a filter (30; 300) adapted to remove particulate material (120) from a gas (40), the method comprising the following method step:
producing at least one electric arc discharge pulse (130; 135; 140), the at least one electric arc discharge pulse (130; 135; 140) being adapted to generate at least one electric arc discharge in the filter (30; 300) and thereby at least one pressure wave that dislodges the particulate material (120) trapped in the filter (30; 300) from the filter (30; 300).

2. The method of claim 1, further comprising:
removing the dislodged particulate material (120) from the filter (30; 300), preferably by blowing away or suction.

3. The method of claim 1 or 2, wherein at least one series of electric arc discharges in the filter (30; 300) caused by at least one series of electric arc discharge pulses (130; 135; 140) is produced, the at least one series of electric arc discharge pulses (130; 135; 140) being adapted to generate pressure waves that dislodge the particulate material (120) trapped in the filter (30; 300) from the filter (30; 300).

4. The method of one or more of the preceding claims, wherein the at least one electric arc discharge pulse (130; 135; 140) has a minimum peak pulse current of about 10 A, preferably about 50 A and/or a maximum peak pulse current of about 1000 A, preferably about 100 A.

5. The method of claim 3 or 4, wherein the electric arc discharge pulses include pulses (130; 135; 140) having a pulse energy release per electric discharge length of about 0.1 mJ/mm to 100 mJ/mm, preferably between 1 mJ/mm to 10 mJ/mm.

6. The method of one or more of the preceding claims, wherein the pulse rise time (rt) of each electric arc discharge pulse (130; 135; 140) is about 10⁻⁹ s to 10⁻⁷ s, preferably 10⁻⁸ s.

7. The method of one or more of the preceding claims, wherein the number of pulses is up to 10⁶ per litre of filter volume, preferably 10³ pulses per litre to 10⁵ pulses per litre, and/or preferably the pulse repetition rate is between about 5 Hz to 50 Hz, preferably about 10 Hz to 20 Hz.

8. The method of one or more of the preceding claims, further comprising reiterating the sequence of producing the at least one series of electric arc discharge pulses (130; 135; 140).

9. The method of one or more of the preceding claims, wherein the pulse width is about 1 to 1000 ns, preferably 10 to 500 ns, more preferably about 50 ns.

10. The method of one or more of the preceding claims, wherein a minimum pulse height is about 2 A.

11. The method of one or more of the preceding claims, wherein at least one first electrode (100) and at least one second electrode (110) are arranged, and the method further comprising generating electric arc discharges between the at least one first electrode and the at least one second electrode (100, 110) by the at least electric arc discharge pulse, preferably the at least one series of electric arc discharge pulses (130; 135; 40).

12. The method of one or more of the preceding claims, wherein the filter (30; 300) comprises at least one filter wall (55; 300) having an outlet side (310) opposite an inlet side (305), and at least one first and at least one second electrode (100, 110), the at least one first electrode (100) being arranged at the inlet side (305) or the outlet side (310) and the at least one second electrode (110) being arranged at the inlet side (305) or the outlet side (310),
the method further comprising generating electric arc discharges between the at least one first and second electrodes (100, 110) at or through the filter wall (55; 300) by the at least one electric arc discharge pulse, preferably the at least one series of electric arc discharge pulses (130; 135; 40).

13. The method of one or more of the preceding claims, wherein an engine particulate filter, e.g. a diesel engine particulate filter (30; 300), is being regenerated, and the particulate material includes engine fuel combustion products, such as diesel engine particulate material and/or soot (120) and/or ash.

14. A filter regenerating arrangement (5), comprising:
a pulse generating device (70) adapted to generate at least one electric arc discharge pulse (130; 135; 140), the at least one electric arc discharge pulse (130; 135; 140) being adapted to generate at least one electric arc discharge and thereby at least one pressure wave within a filter (30; 300) that causes particulate material (120) trapped in the filter (30; 300) to be dislodged from the filter (30; 300).

15. The filter regenerating arrangement of claim 14, further comprising:
a particulate removing device (90; 95) adapted to remove the dislodged particulate material (120) from the filter (30; 300).

16. The filter regenerating arrangement of claim 14 or 15, wherein the pulse generating device (70) is adapted to generate at least one series of electric arc discharge pulses (130; 135; 140), the series of electric arc discharge pulses (130; 135; 140) being adapted to generate electric arc discharges and thereby pressure waves within a filter (30; 300) that causes particulate material (120) trapped in the filter (30; 300) to be dislodged from the filter (30; 300).

17. The filter arrangement of one or more of claims 14-16, wherein the filter (30; 300) comprises at least one filter wall (55; 300) having an inlet side (305) adapted to trap particulate material (120) and an outlet side (310) opposite the inlet side (305), and at least one first electrode (100) and at least one second electrode (110) which electrodes are adapted to produce electric arc discharges within the filter (30; 300).

18. The filter arrangement of one or more of claims 14-17, wherein at least one first electrode (100), in particular a ground electrode, is arranged in the filter (30; 300), and at least one second electrode (110), preferably an active electrode (110), is at a distance to the first electrode (100).

19. The filter arrangement of claim 18, wherein a plurality of first electrodes (100) are connected with each other and/or a plurality of second electrodes (110) are connected with each other.

20. The filter arrangement of claim 19, wherein the plurality of second electrodes (110) are uniformly distributed at a distance to the at least one first electrode (100).

21. The filter arrangement of one or more of claims 14-20, wherein several first electrodes (100) are arranged in the filter (30; 300) and each first electrode (100) is associated with two or more second electrodes (110) which are at a distance to the respective first electrode (100).

22. The filter arrangement of one or more of the claims 14-21, wherein the pulse generating device (70) comprises a voltage supply (225), preferably a DC voltage supply, and at least one group of electrodes comprising at least one first electrode (100) and at least one second electrode (110), wherein the at least one first electrode (100) is connected to a high voltage terminal and the at least one second electrode (110) of the same group of electrodes are connected to ground.

23. The filter arrangement of claim 22, further comprising an inverter (205) adapted to change the polarity of the terminals.

24. The filter regenerating arrangement of one or more of the claims 15-23, wherein the particulate removing device (90; 95) includes a blower device, preferably a low pressure blower, adapted to blow the dislodged particulate material (120) out of the filter (30; 300) into a storage device (90).

25. The filter regenerating arrangement of one or more of the claims 15-23, wherein the particulate removing device (90; 95) includes a suction device (95) adapted to suck the dislodged particulate material (120) into a storage device (90).

26. The filter regenerating arrangement of one or more of claims 14-25, wherein the pulse generating device (70) is adapted to generate electric arc discharge pulses each having a minimum peak pulse current of about 10 A and/or a maximum peak pulse current of about 1000 A, preferably about 100 A.

27. The filter regenerating arrangement of one or more of claims 14-26, wherein the pulse generating device (70) is adapted to generate at least one series of electric arc discharge pulses including pulses (130; 135; 140) having a pulse energy release per electric arc discharge length of about 0.1 mJ/mm to 100 mJ/mm, preferably between 1 mJ/mm to 10 mJ/mm.

28. The filter regenerating arrangement of one or more of claims 14-27, wherein the pulse generating device (70) is adapted to generate electric arc discharge pulses each having a pulse rise time of about 10⁻⁹ s to 10⁻⁷ s, preferably 10⁻⁸ s.

29. The filter regenerating arrangement of one or more of claims 14-28, wherein the pulse generating device (70) is adapted to generate at least one series of electric arc discharge pulses (130; 135; 140) wherein the number of pulses is up to 10⁶ per litre of filter volume, preferably 10³ pulses per litre to 10⁵ pulses per litre, preferably having a pulse repetition rate of about 5 Hz to 50 Hz, preferably 10 Hz to 20 Hz.

30. The filter regenerating arrangement of one or more of claims 14-29, further comprising a filter (30; 300) adapted to remove particulate material (120) from a gas (40), e.g. a monolithic particulate filter.

31. A diesel particulate filter (30, 300), having a filter material (55) adapted to trap particulate material, wherein the filter material has a maximum temperature resistance of about 600° C., preferably of about 500° C. to 550° C., or more preferably of about 400° C. to 450° C.

32. The diesel particulate filter (30, 300) of claim 31, further comprising at least one pair of electrodes (100, 110) adapted to generate electric arc discharges in the filter (30; 300) caused by at least one electric arc discharge pulse (130; 135; 140), and, thereby, causing that at least one pressure wave is generated within the filter (30; 300) resulting in the particulate material (120) trapped in the filter (30; 300) is being dislodged from the filter (30; 300).

33. The diesel particulate filter (30; 300) of claim 31 or 32, wherein the filter material is selected from the group consisting of ceramic, preferably cordierite, and paper.

34. The use of at least one electric arc discharge configured to not burn a particulate material trapped in a filter but to dislodge the particulate material trapped in the filter from the filter.
